(19) United States
(12) Patent Application Publication
(10) Pub. No.: US 2026/0296482 A1
(43) Pub. Date: Oct. 1, 2026

(54) SYSTEMS AND METHODS FOR GLOBAL LOCALIZATION USING MULTIPLE MODELS AND A MAP

(71) Applicant: Toyota Jidosha Kabushiki Kaisha, Toyota-shi Aichi-ken (JP)

(72) Inventor: Alexander Christoph Schaefer, Fremont, CA (US)

(73) Assignee: Toyota Jidosha Kabushiki Kaisha, Toyota-shi Aichi-ken (JP)

(21) Appl. No.: 19/090,868

(22) Filed: Mar. 26, 2025

(51) Int. Cl. B60W 60/00; B60W 50/00; G06N 7/01

(52) U.S. Cl. CPC B60W 60/001; B60W 50/0097; G06N 7/01; B60W 2050/0056; B60W 2556/40

(57) ABSTRACT

Systems, methods, and other embodiments described herein relate to globally localizing a vehicle using transition and state probabilities associated with a standard map. In one embodiment, a method includes computing emission probabilities for a road position from sensor data and a map about a road. The method also includes estimating transition probabilities of the road position on a trellis graph from the sensor data and the map. The method also includes predicting state probabilities from the emission probabilities and the transition probabilities using a Markov model. The method also includes controlling a vehicle from vehicle locations using the state probabilities, and the vehicle locations being topological locations.

### TECHNICAL FIELD

The subject matter described herein relates, in general, to a global localization of a vehicle, and, more particularly, to localizing the vehicle using multiple models that predict various motion probabilities with a standard map.

### BACKGROUND

Sensors on a vehicle generate data that facilitate perceiving other vehicles, obstacles, roads, etc., of a driving environment. For instance, a vehicle equipped with a light detection and ranging (LIDAR) sensor uses light to scan an environment. This allows downstream logic associated with the LIDAR to analyze acquired data and detect object presence during vehicle travel. In further examples, additional sensors such as cameras are implemented to acquire information about the driving environment. This allows a system to derive awareness about aspects of the surrounding environment. In this way, the sensor data and object presence can improve perceptions of the surrounding environment so that systems such as positioning and automated driving systems (ADS) can accurately plan and navigate a driving environment during vehicle travel.

In another approach, systems derive a vehicle direction and path for downstream applications that control various vehicle features. Certain of these downstream applications (e.g., safety control, automated driving, etc.) demand precise and detailed information about a driving environment. For instance, an intersection crossing system that executes driving commands from the ADS encounters unknown safety hazards using a digital map that lacks reliable road and lane information. In response, certain systems acquire and implement a high-definition (HD) map during vehicle travel and estimate the position of the vehicle using the HD map. These systems implementing HD maps demand high-speed communications and processing of vast data. Acquiring vast data and installing complex hardware associated with HD maps can be unavailable for certain vehicle platforms, such as basic vehicles. Accordingly, these demands hinder positioning and localization availability and capabilities for vehicle systems and control, thereby sacrificing safety.

### SUMMARY

In one embodiment, example systems and methods relate to globally localizing a vehicle using transition and state probabilities associated with a standard map. In various implementations, systems rely upon a high-definition (HD) map for basic and advanced tasks during vehicle travel. For instance, a vehicle receives commands from an automated driving system (ADS). Here, the ADS estimates trajectories using the HD map to make a turn at an intersection. For example, the HD map includes detailed information about road topology, lane markings, landmarks, and traffic signals. The ADS can leverage these details to accurately and safely determine position for navigating driving scenarios that are complex. However, automated vehicles encounter complexities and data overhead with HD maps due to regular updates for maintaining detailed information. Furthermore, systems that rely upon real-time sensor data and machine learning rather than maps to navigate a road dynamically can be computationally costly. As such, systems navigating a driving scenario selectively with an HD map encounter technical difficulties and resource costs, thereby hindering automation and basic tasks.

Therefore, in one approach, a prediction system globally localizes a vehicle against a standard map through predicting state probabilities from emission and transition probabilities using a Markov model. In particular, a hidden Markov model (HMM) statistically represents vehicle travel and roads with hidden states. Furthermore, observable outputs using probabilities describe transitions between states so that observation generation can localize the vehicle. Here, the standard map can be an enhanced standard definition (ESD) map that improves geometric accuracy and produces topological locations for the vehicle. The state can be an association between a road (e.g., a road identification) and a lane that the vehicle is currently traversing. For example, the ESD map is a simplified form of the HD map. In this way, the prediction system can assist in the control of the vehicle using the topological vehicle while avoiding costs and complexities associated with an HD map.

In another approach, the prediction system computes the emission probabilities for a road position using the ESD map associated with a road where a vehicle is traversing the road. For example, an emission probability reflects a probability about a path potentially taken by the vehicle. The path is related to a graph associated with the Markov model for the road. Furthermore, the prediction system can estimate transition probabilities of the road position and the path on the graph using the ESD map. In this way, the prediction system can accurately output global location for controlling the vehicle using the emission and transition probabilities and an ESD map, thereby avoiding difficulties associated with the HD map.

In one embodiment, a prediction system for globally localizing a vehicle using transition and state probabilities associated with a standard map is disclosed. The prediction system includes a memory storing instructions that, when executed by a processor, cause the processor to compute emission probabilities for a road position from sensor data and a map about a road. The instructions also include instructions to estimate transition probabilities of the road position on a trellis graph from the sensor data and the map. The instructions also include instructions to predict state probabilities from the emission probabilities and the transition probabilities using a Markov model. The instructions also include instructions to control a vehicle from vehicle locations using the state probabilities, and the vehicle locations being topological locations.

In one embodiment, a non-transitory computer-readable medium for globally localizing a vehicle using transition and state probabilities associated with a standard map and including instructions that when executed by a processor cause the processor to perform one or more functions is disclosed. The instructions include instructions to compute emission probabilities for a road position from sensor data and a map about a road. The instructions also include instructions to estimate transition probabilities of the road position on a trellis graph from the sensor data and the map. The instructions also include instructions to predict state probabilities from the emission probabilities and the transition probabilities using a Markov model. The instructions also include instructions to control a vehicle from vehicle locations using the state probabilities, and the vehicle locations being topological locations.

In one embodiment, a method for globally localizing a vehicle using transition and state probabilities associated with a standard map is disclosed. In one embodiment, the method includes computing emission probabilities for a road position from sensor data and a map about a road. The method also includes estimating transition probabilities of the road position on a trellis graph from the sensor data and the map. The method also includes predicting state probabilities from the emission probabilities and the transition probabilities using a Markov model. The method also includes controlling a vehicle from vehicle locations using the state probabilities, and the vehicle locations being topological locations.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a prediction system that globally localizes a vehicle using transition and state probabilities associated with a standard map.

FIGS. 3A-3C illustrate embodiments of the prediction system finding candidate roads and implementing a Markov model using a graph for global localization from the standard map.

FIG. 4 illustrates one embodiment of a method that is associated with controlling a vehicle from topological vehicle locations derived with state probabilities using the Markov model and the standard map.

### DETAILED DESCRIPTION

Systems, methods, and other embodiments associated with globally localizing a vehicle using transition and state probabilities related to a standard map are disclosed herein. In various implementations, systems localize and position a vehicle within a driving environment using a high-definition (HD) map. These systems may leverage vast data and complex sensors for the localization. Acquiring the vast data and implementing the complex sensors can be unreasonable for certain vehicle platforms. Furthermore, sometimes localizing the vehicle using heuristics with positioning data (e.g., global positioning data (GPS)) can explicitly correlate positioning data with road position without the HD map. Still, this approach can lead to inaccurate map geometries and estimating poor topological locations for the vehicle under certain circumstances.

Therefore, in one embodiment, a prediction system estimates topological locations during vehicle travel through reliable convergence scaling, identifying accurate transition probabilities on a trellis graph about a road, and predicting state probabilities with the Markov model for the road. The prediction system does so using a standard map that avoids the complexities and computational costs of an HD map. The standard map can be an enhanced standard definition (ESD) map that improves geometric accuracy and produces topological locations for a vehicle during the vehicle travel. Yet, an ESD map avoids the complexities and the computational costs associated with an HD map. Furthermore, the scaling of the Markov model may involve an exponentiation computation from a distance traveled by the vehicle and emission probabilities associated with the road. In this way, the prediction system increases efficiency by avoiding scaling at a frequency associated with updating the emission probabilities that reflect a probability about a path potentially taken by the vehicle.

In various implementations, the prediction system estimates transition probabilities of a road position and a path on the trellis graph using the ESD map. Here, a transition model for the Markov model that is stable and efficient can involve making transition computations independent of a vehicle speed. For example, the transition model can depend upon a quotient of odometry and route distance about the vehicle. Furthermore, the trellis graph can be divided into various timesteps between state probabilities, the emission probabilities, and the transition probabilities for relating road elements. In one approach, the prediction system derives the transition probabilities and predicts the state probabilities from the emission and the transition probabilities using the Markov model. For instance, a state probability indicates a state space including an x-coordinate, y-coordinate, and a heading associated with a topological location of a vehicle. This allows the prediction system to determine a road identification (road ID) and association for the vehicle using the Markov model according to a previous road association among various timesteps structured with the trellis graph. In another approach, controlling the vehicle involves deriving a state probability from the topological location. Accordingly, the prediction system accurately outputs global location for controlling the vehicle using a state probability derived from emission and transition probabilities and an ESD map, thereby avoiding complexities from relying upon an HD map and costly hardware for global localization.

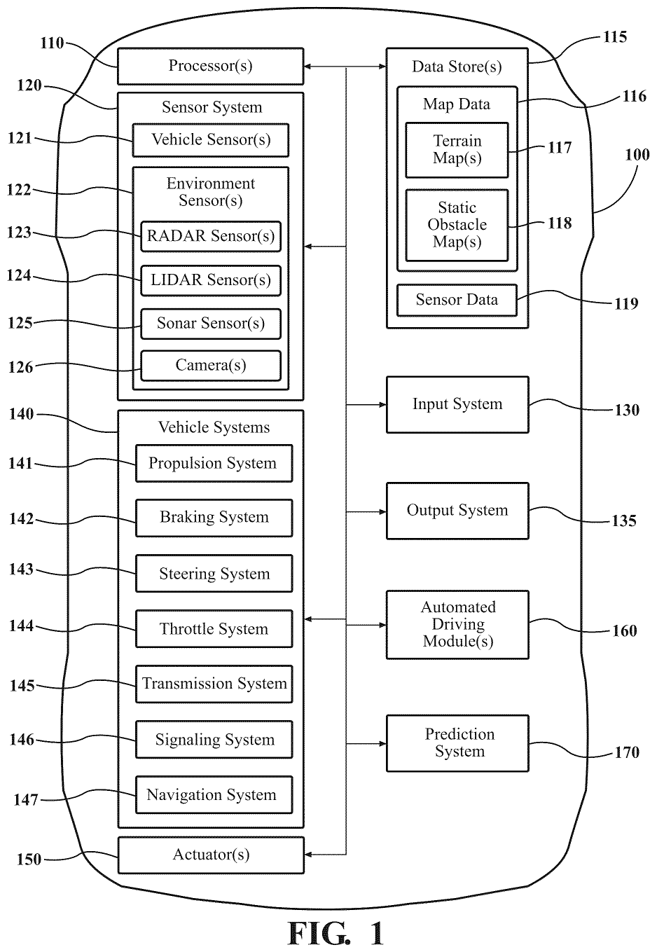

Referring to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. In some implementations, a prediction system 170 uses road-side units (RSU), consumer electronics (CE), mobile devices, robots, drones, and so on that benefit from the functionality discussed herein associated with globally localizing a vehicle using transition and state probabilities related to a standard map.

The vehicle 100 also includes various elements. It will be understood that in various embodiments, the vehicle 100 may have less than the elements shown in FIG. 1. The vehicle 100 can have any combination of the various elements shown in FIG. 1. Furthermore, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Furthermore, the elements shown may be physically separated by large distances. For example, as discussed, one or more components of the disclosed system can be implemented within a vehicle while further components of the system are implemented within a cloud-computing environment or other system that is remote from the vehicle 100.

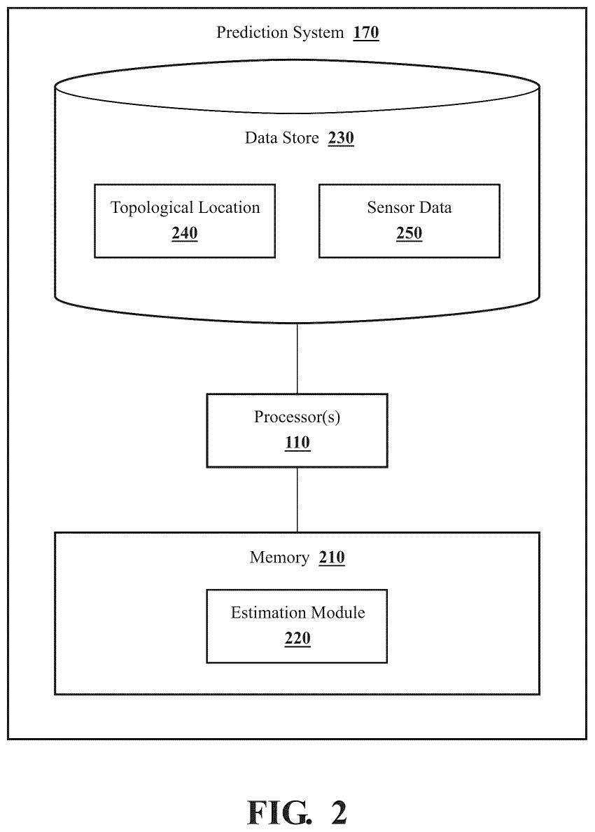

Some of the possible elements of the vehicle 100 are shown in FIG. 1 and will be described along with subsequent figures. However, a description of many of the elements in FIG. 1 will be provided after the discussion of FIGS. 2-4 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of ordinary skill in the art, however, will understand that the embodiments described herein may be practiced using various combinations of these elements. In either case, the vehicle 100 includes the prediction system 170 that is implemented to perform methods and other functions as disclosed herein relating to globally localizing a vehicle using transition and state probabilities associated with a standard map. As will be discussed in greater detail subsequently, the prediction system 170, in various embodiments, is implemented partially within the vehicle 100, and as a cloud-based service. For example, in one approach, functionality associated with at least one module of the prediction system 170 is implemented within the vehicle 100 while further functionality is implemented within a cloud-based computing system.

With reference to FIG. 2, one embodiment of the prediction system 170 of FIG. 1 is further illustrated. The prediction system 170 is shown as including a processor(s) 110 from the vehicle 100 of FIG. 1. Accordingly, the processor(s) 110 may be a part of the prediction system 170, the prediction system 170 may include a separate processor from the processor(s) 110 of the vehicle 100, or the prediction system 170 may access the processor(s) 110 through a data bus or another communication path. In one embodiment, the prediction system 170 includes a memory 210 that stores an estimation module 220. The memory 210 is a random-access memory (RAM), a read-only memory (ROM), a hard-disk drive, a flash memory, or other suitable memory for storing the estimation module 220. The estimation module 220 is, for example, computer-readable instructions that when executed by the processor(s) 110 cause the processor(s) 110 to perform the various functions disclosed herein.

The prediction system 170 as illustrated in FIG. 2 is generally an abstracted form of the prediction system 170 that may be implemented in the vehicle 100. Furthermore, the prediction system 170 and/or estimation module 220 generally include instructions that function to control the processor(s) 110 to receive data inputs from one or more sensors of the vehicle 100. The inputs are, in one embodiment, observations of one or more objects in an environment proximate to the vehicle 100 and/or other aspects about the surroundings. As provided for herein, the prediction system 170 and/or the estimation module 220, in one embodiment, acquire sensor data 250 that include at least camera images. In further arrangements, the prediction system 170 and/or the estimation module 220 acquire the sensor data 250 from further sensors such as radar sensors 123, LIDAR sensors 124, and other sensors as may be suitable for identifying vehicles and locations of the vehicles.

Accordingly, the prediction system 170 and/or the estimation module 220, in one embodiment, control the respective sensors to provide the data inputs in the form of the sensor data 250. Additionally, while the prediction system 170 and/or the estimation module 220 are discussed as controlling the various sensors to provide the sensor data 250, in one or more embodiments, the elements implement other techniques to acquire the sensor data 250 that are either active or passive. For example, the estimation module 220 passively sniffs the sensor data 250 from a stream of electronic information provided by the various sensors to further components within the vehicle 100. Moreover, the prediction system 170 and/or the estimation module 220 can undertake various approaches to fuse data from multiple sensors when providing the sensor data 250 and/or from sensor data 250 acquired over a wireless communication link. Thus, the sensor data 250, in one embodiment, represents a combination of perceptions acquired from multiple sensors.

In addition to locations of surrounding vehicles, the sensor data 250 includes, for example, information about lane markings, and so on. Moreover, the prediction system 170, in one embodiment, controls the sensors to acquire the sensor data 250 about an area that encompasses 360 degrees about the vehicle 100 in order to provide a comprehensive assessment of the surrounding environment. Of course, in alternative embodiments, the prediction system 170 acquires the sensor data 250 about a forward direction alone when, for instance, the vehicle 100 is not equipped with further sensors to include additional regions about the vehicle and/or the additional regions are not scanned due to other reasons.

Moreover, in one embodiment, the prediction system 170 includes a data store 230. In one embodiment, the data store 230 is a database. The database is, in one embodiment, an electronic data structure stored in the memory 210 or another data store and that is configured with routines that can be executed by the processor(s) 110 for analyzing stored data, providing stored data, organizing stored data, and so on. Thus, in one embodiment, the data store 230 stores data used by the estimation module 220 in executing various functions. In one embodiment, the data store 230 includes the sensor data 250 along with, for example, metadata that characterize various aspects of the sensor data 250. For example, the metadata can include location coordinates (e.g., longitude and latitude), relative map coordinates or tile identifiers, time/date stamps from when the separate sensor data 250 was generated, and so on. In one embodiment, the data store 230 further includes topological location 240. For instance, the topological location 240 includes one of a road-level localization and a lane-level localization between the vehicle 100, a road, and lanes among the road. Furthermore, localized position about the vehicle 100 may include one of a lane ID, a road ID, a longitudinal position for the road ID using a standard map (e.g., an ESD map), and a heading, thereby avoiding relying upon an HD map. This allows the prediction system 170 to derive one of a road-level localization and a lane-level localization about the vehicle 100 traveling on the road 300.

Moreover, the topological location 240 can include a road ID for the vehicle 100 traveling on the road. As explained below, the prediction system 170 identifying the topological location 240 can include deriving various road and lane associations. This can include deriving an association between the vehicle 100 and the road 300 using the lane-level localization relative to a standard map. Subsequently, the prediction system 170 globally localizes the vehicle 100 using the association and a standard map rather than an HD map.

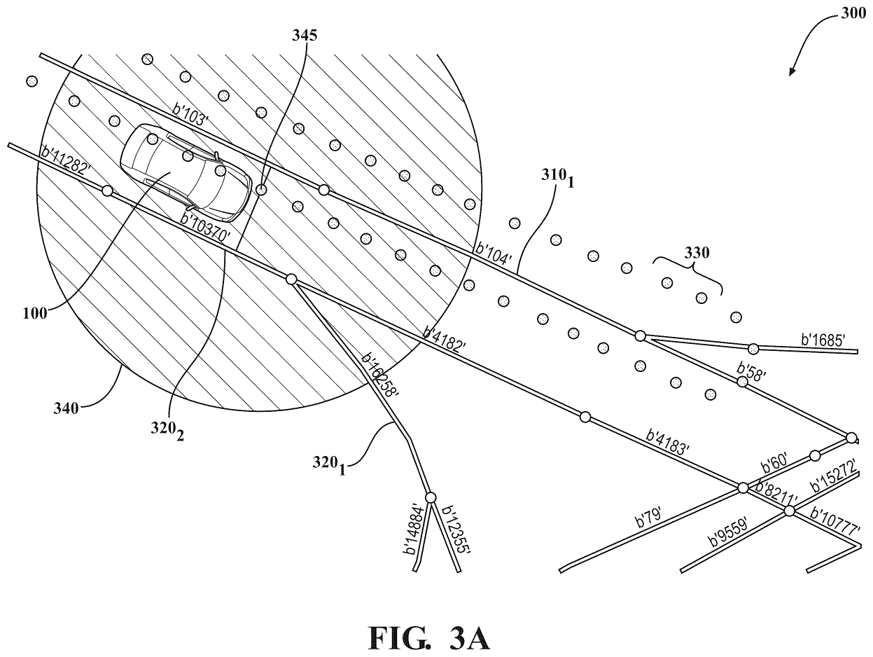

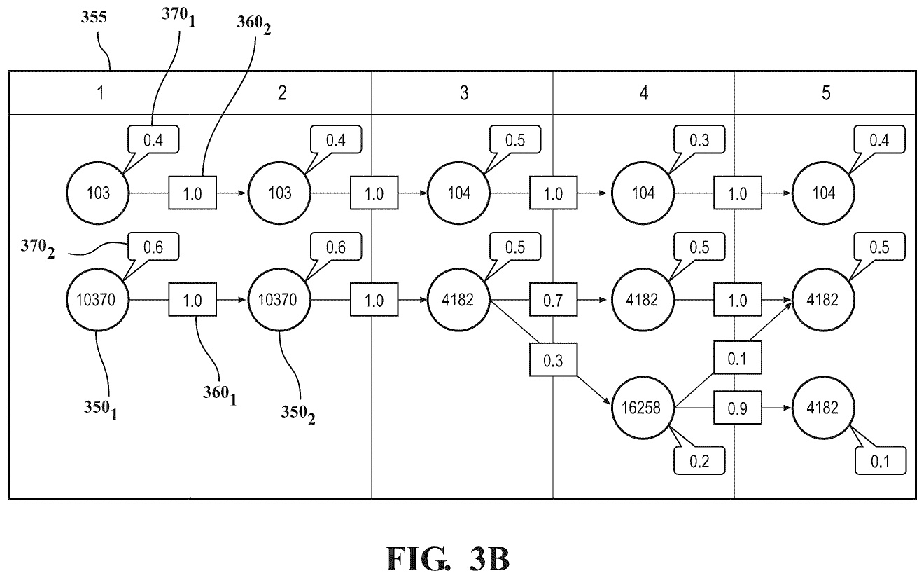

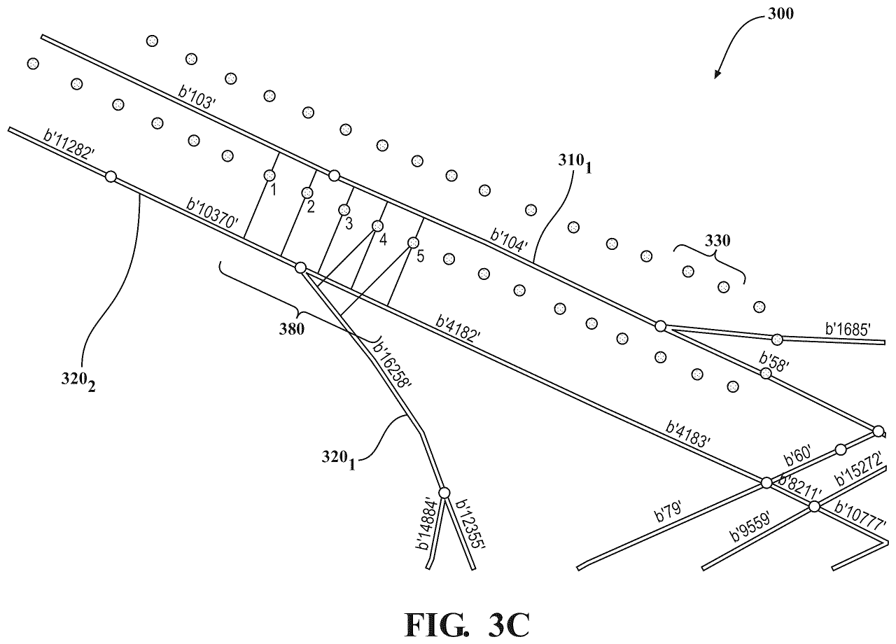

Now turning to FIGS. 3A-3C, embodiments of the prediction system 170 finding candidate roads and implementing the Markov model using a graph for global localization from a standard map are illustrated. In one approach, the prediction system 170 includes instructions that cause the processor 110 to compute emission probabilities for a road position from the sensor data 250 and a map about a road 300. Here, the map can be one of a standard map and an ESD map that includes centerline information about the road 300, a number of lanes for the road 300, and a topology for the road 300. In one approach, the number of lanes are associated with one of a segment and a portion about the road 300. The ESD map may exclude lane geometries about the road 300. In another approach, the ESD map involves adding layers on a standard map. A layer can include the number of lanes corresponding to the topology for a road segment. Furthermore, lane information can include inbound and outbound transitions. However, the ESD map can exclude explicit lane geometries, thereby reducing computational costs and straining communication links associated with keeping HD maps current.

The estimation module 220 can estimate transition probabilities of the road position on a trellis graph from the sensor data 250 and the map. In another approach, estimating the transition probabilities includes using a transition model according to one of a quotient between odometry information and the distance traveled along a road graph, a lateral offset between the vehicle 100 and a centerline of the road 300, an area between a trajectory and a path on the road graph associated with the vehicle 100. Here, the road graph can represent a network of roads in a map that simplifies computations through relating road elements. The edges of the road graph represent roads while the nodes represent connections between roads. As such, the prediction system 170 can predict state probabilities from the emission probabilities and the transition probabilities using a Markov model. In an application, one or more vehicle systems 140 control the vehicle 100 from vehicle locations using the state probabilities, and the vehicle locations being the topological location 240 without using an HD map, thereby improving localization while reducing system complexity and vehicle costs.

As further explained below, in another approach, the prediction system 170 can scale emissions associated with the Markov model using an exponentiation computation. For instance, the scaling corresponds with a distance traveled by the vehicle 100. Emission probabilities can be associated with the road 300 and the state probabilities can depend upon the exponentiation computation and the emission probabilities. As also further explained below, in yet another approach, the prediction system 170 computes the emission probabilities by generating a geometric pose using an extended Kalman filter (EKF) from odometry information and the road position. Here, the road position is associated with the vehicle 100 traveling on the road 300, the geometric pose includes an x-coordinate, a y-coordinate, and a heading for the vehicle 100. In FIG. 3A, the geometric pose can be associated with a search radius 340 for the transition probabilities.

Moreover, predicting state probabilities from the emission probabilities using a Markov model can include deriving a perception about the road 300 across timesteps, time intervals, etc., using the sensor data 250. For instance, the prediction system 170 projects a road position to various locations within the search radius 340 and assigns a score to the emission probabilities from the perception using sensor system 120. The search radius 340 can indicate a hypothetical path and trajectory for the vehicle 100 that the prediction system 170 utilizes at time 1 to derive the topological location 240 using a standard map, thereby avoiding costs involving HD maps.

In another embodiment, as described in detail below, predicting the state probabilities includes comparing topological states for the transition probabilities. Here, the transition probabilities can be associated with the vehicle 100 for a path using a trellis graph 355 such that the path is measured along a road graph for the road 300. For example, the trellis graph 355 is divided into one or more timesteps between the topological states and the emission probabilities and the transition probabilities form the trellis graph 355. A topological state can be associated with various parameters including the topological location 240. In this way, the prediction system 170 can assign a trajectory probability using a difference between a distance traveled by the vehicle 100 and the path between the topological states. As an example, the path is measured along the road graph that allows global localization with a standard map using the trellis graph 355.

In FIG. 3A, the road 300 is diagrammed as a standard map (e.g., an ESD map). The labeled lines 310₁, 320₁, and 320₂ can represent one of lines, lane lines, centerlines, boundaries, etc., associated with the road 300. The lines can be one of perceived using the sensor data 250 by the vehicle 100 and existing from the standard map. As further explained below, trajectory points 330 of the vehicle 100 can be estimated by an EKF. In one approach, estimating vehicle trajectory and the topological location 240 can involves implementing a hidden Markov model (HMM) that is non-homogeneous. An HMM can be computationally efficient and stable through the rapid convergence of possible states. This may include the prediction system 170 executing computations using a distance traveled. In this way, a convergence rate is distance-dependent rather than time-dependent for the HMM. This reduces computational cycles associated with sampling data and increases localization performance using the HMM. For instance, the vehicle 100 stopped at a traffic light on the road 300 has a static value for the topological location 240 making sampling less demanded. In other words, the vehicle traveling at a slow speed, stopped, etc., exhibits measurements that are dependent with the sensor data 250 indicating similar information repeatedly. As such, the prediction system weighting measurements by distance traveled boosts performance.

Regarding details about convergence, in another embodiment, the prediction system 170 during convergence scaling implements a convergence rate triggered upon a distance traveled. This avoids convergence that relies on a frequency that the vehicle 100 processes data, thereby decreasing computational costs. The efficiency benefits can be demonstrated through assuming that the vehicle 100 generates constant emission probabilities pᵢ, where i is a road ID of the road 300. After one second(s), a state can have a weight of pᵢ**f, where f is the update frequency. Here, convergence is a function of time rather than a distance traveled for the vehicle 100. Transforming convergence to a function of distance traveled, we exponentiate every pᵢ by d/f, where d is the distance traveled since the last update. After one second, the state probabilities are:

$${p}_{i} ** ( d / f ) ** f = {p}_{i} ** d . \qquad Equation ( 1 ) ,$$

where ** indicates exponentiation. In other words, a state probability can relate and exponentiate a weight derived from an emission probability by distance traveled over various timesteps and road segments drawn from a map (e.g., a standard map, an ESD map, etc.). In this way, location, trajectory, path, etc., predictions for the vehicle 100 relies upon a distance traveled with Equation (1) rather than time, thereby reducing computational loads.

Concerning FIG. 3B, the trellis graph 355 illustrates localization of the vehicle 100 using the prediction system 170, an HMM, and an ESD map. Here, a sequence state 350₁ is associated with a road ID that is labeled. Different sequence states are separated by timesteps 1-5. Timestep 1 can be t, timestep 2 can be t+1, timestep 3 can be t+2, etc. A transition probability 360₁ indicates the vehicle 100 moving between the sequence state 350₁ to a sequence state 350₂. Emission probabilities 370₁ and 370₂ can indicate a probability about a path potentially taken by the vehicle 100 between sequence states upon a distance traveled.

In an embodiment, the prediction system 170 derives the transition probability 360₁ using a quotient between a distance traveled (e.g., actual distance, measured distance, etc.) and a distance traveled on the trellis graph 355. As such, in an embodiment, transitions are computed independent of vehicle speed and depend upon a quotient between odometry and a route distance for the vehicle 100. Transitions can also be based on a change in a lateral offset between the vehicle 100 and the road centerline, an area between a vehicle trajectory and a path on the trellis graph 355, etc. In this way, the prediction system 170 implements localization with an ESD map that exhibits robustness against inaccurate and incomplete map data with computational efficiency.

Global localization can also involve an EKF generating an optimal geometric pose using odometry and positioning information. For instance, the navigation system 147 outputs the positioning information about the vehicle 100. In yet another example, an HMM tracks the topological location 240 and road associations for road-level localization and vehicle-lane association associated with lane-level localization. In one approach, the road-level localization is a subset of the lane-level localization. In other words, the prediction system 170 identifying the lane-level association for the vehicle 100 can derive a road-level association through looking up a lane-road association on the ESD map.

The prediction system 170 can also utilize the EKF to estimate a geometric state about the vehicle 100 optimally. In one approach, a state space for a geometric state includes one of an x-coordinate, a y-coordinate, and a heading with respect to the local Universal Transverse Mercator (UTM) zone. The state space is associated with the topological location 240 indicating a road ID for the vehicle 100 during current travel. In one approach, the state space is discrete having a set of road IDs on a map. Furthermore, identifying a current road association through an HMM can begin with a last road association and estimating observations using the sensor data 250 and positioning information. The navigation system 147 can compute the positioning information using data from one of a global navigation satellite system (GNSS), a GPS, etc.

In the trellis graph 355, a probability that the vehicle 100 transitions between roads can exhibit variable values on a standard map (e.g., an ESD map). In one approach, the probability varies by the position of the vehicle 100 along the road 300. For instance, the vehicle 100 being located at the start of the road 300 indicates the vehicle 100 unlikely will enter another road at t+1. The vehicle 100 can have an increased probability of entering another road at t+1 when located at the end of the road 300 rather than the start. As such, transition probabilities can depend on external variables that are untracked by the HMM. On the road 300, these external variables can include the geometric state: x, y, and heading. This can result in the prediction system 170 recognizing a non-homogeneous hidden Markov model (NH-HMM) for localization (e.g., global localization, road localization, etc.) during Markov implementation.

Regarding further details about probability computations and deriving the topological location 240, the prediction system 170 can initialize at time t=1. The EKF can output a geometric state estimate 345. From here, estimating a road association for the vehicle 100 can involve using the search radius 340 that includes candidate associations. The prediction system 170 can project a position of the vehicle 100 and identify a candidate association not falling between starting and ending points for a road. As such, the prediction system 170 may discard this candidate association.

On the road 300, candidate associations b‘103’ and b‘10370’ remain after iterations and position projections associated with the vehicle 100 for upcoming timesteps. Further localizing the vehicle 100 can involve assigning emission probabilities that score observations derived with the sensor data 250. For instance, a perception system of the vehicle 100 indicates that the road b‘103’ has two lanes. The prediction system 170 assigns an elevated emission probability if a standard map verifies in fact that the road b‘103’ has two lanes.

In yet another example, the prediction system 170 derives a probability from a distance between position projection involving the vehicle 100 onto the road 300 and the position reported by the navigation system 147 (e.g., a GNSS, a GPS, etc.). A probability can also be derived from comparing a lane count reported by the ESD map and a vehicle message at t=1. Furthermore, the prediction system 170 proceeds with computations advancing to t=2. The prediction system 170 again builds a set of road candidates through searching a search radius associated with a current geometric estimate. The prediction system 170 checks if the projection falls between the start and end points of the candidate road.

Regarding an implementation detail, in another embodiment, the prediction system 170 and/or estimation module 220 compute transition probabilities from a previous topological state qₜ₋₁ to a current state qₜ using the trellis graph 355 and indicates likely travel paths for the vehicle 100. For example, the protocol checks whether a path in the trellis graph 355 exists for a state pair (qₜ₋₁,qₜ). If not, the prediction system 170 sets the corresponding transition probability to zero. In the trellis graph 355, the vehicle 100 traversing from road ID 103 (e.g., b‘103’) to road ID 104 (e.g., b‘104’) between the timesteps 2 and 3 can have a transition probability 1.0. This indicates that the path for the vehicle 100 and a road association is possible, likely, etc. Similarly, the vehicle 100 traversing from road ID 10370 (e.g., b‘10370’) to road ID 4182 (e.g., b‘4182’) between the timesteps 2 and 3 can have a transition probability 1.0 indicating that the path is possible.

The prediction system 170 assigns a transition probability 360₁, 360₂, etc., if a path exists between topological states path. For instance, the transition probability 360₂ is derived according to a difference between the distance traveled (e.g., 5 meters (m)) by the vehicle 100 and the distance between the states represented along the trellis graph 355. After having inferred possible transition probabilities, the prediction system 170 can compute the emission probabilities 370₁, 370₂, etc., that represent percentage weights for various road IDs. The percentage weight can be associated with a distance that is closest to a centerline of the road 300, lane numbers observed compared with lane numbers on the ESD map, etc.

Still referring to FIG. 3B, an off-ramp among the road 300 is illustrated in the trellis graph 355 between timesteps 2 to 4. Here, the vehicle 100 can travel from road IDs 10370->4182->16258 with corresponding emission probabilities 0.6->0.5->0.2 and transition probabilities 1.0 and 0.3, respectively. On the contrary, the vehicle 100 can travel from road IDs 10370->4182->4182 with corresponding emission probabilities 0.6->0.5->0.5 and transition probabilities 1.0 and 0.7. As such, the vehicle 100 taking path road IDs 10370->4182->4182 is more likely than 10370->4182->16258. In other words, the trellis graph 355 indicates that the vehicle 100 is unlikely to take the off-ramp.

In various implementations, the prediction system 170 finding a likely road association at a timestep involves identifying probable state sequences through the trellis graph 355. This can be solved using a forward procedure, which is a recursive algorithm:

$${α}_{1} ( i ) = {b}_{i} ( {O}_{1} ) \qquad Equation ( 2 )$$

$${α}_{t + 1} ( j ) = [ {\sum }_{i = 1}^{N} {α}_{t} ( i ) {a}_{ij} ( t ) ] {b}_{j} ( {O}_{t + 1} ) .$$

Here, αₜ(i)=p(O₁, O₂ . . . Oₜ, qₜ=i) denotes the joint probability of the system state qₜ at time t being road ID i, and observing measurements sequence O₁ . . . Oₜ until time t. The transition probabilities from state i to state j are denoted aᵢⱼ(t). The emission probabilities are denoted bᵢⱼ(Oₜ) and indicate a probability of being in state i given the observation O at time t.

The example in Equation (2) has transition probabilities depending upon t that sometimes is a property of NH-HMM. The prediction system 170 can save resources associated with maintaining and solving a whole state sequence at a timestep since the forward procedure is recursive. As such, updating the set of probabilities {αₜ₋₁(i)} can be sufficient. We can then identify a likely state in a timestep t as i*=argmax αᵢ(t). In conjunction with an EKF for geometric state estimation, the recursive computations increase efficiency.

Now turning to FIG. 3C, the prediction system 170 estimating vehicle-road associations for the vehicle 100 at different timesteps 1-5 is illustrated. FIG. 3C shows a variant of the road 300 with additional information. Here, the timesteps 1-5 may correspond to the trellis graph 355. The measurements 380 can indicate different distances between road IDs b‘103’, b‘10370’, b‘104’, b‘4182’, and b‘16258’ and the trajectory points 330, labeled line 310₁, and labeled line 320₂. This allows the prediction system 170 to reliably and efficiently globally localize the vehicle 100 as previously described using a standard map (e.g., an ESD map) through computing state, emission, and transition probabilities and comparing travel distances on the trellis graph 355.

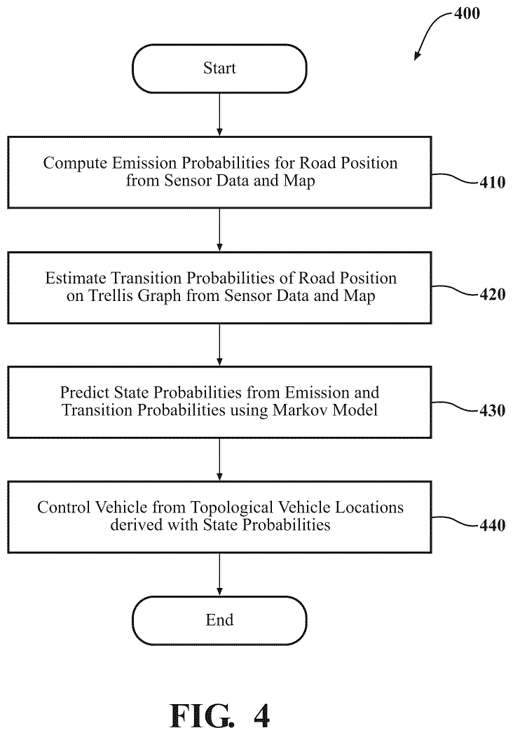

Regarding FIG. 4, one embodiment of a method 400 that is associated with controlling the vehicle 100 from topological vehicle locations derived with state probabilities using the Markov model and the standard map is illustrated. The method 400 will be discussed from the perspective of the prediction system 170 of FIGS. 1 and 2. While the method 400 is discussed in combination with the prediction system 170, it should be appreciated that the method 400 is not limited to being implemented within the prediction system 170 but is instead one example of a system that may implement the method 400.

At 410, the prediction system 170 computes emission probabilities for a road position on a road from the sensor data 250 and a map. The vehicle 100 can be currently traveling on the road described by the map. The road position is associated with the vehicle 100 that the prediction system 170 processes for global localization while avoiding reliance upon an HD map. Here, the map is digital and the map can be one of a standard map having basic information about the road and lanes and an ESD map. In particular, an ESD map can include centerline information about the road, a number of lanes for the road, and a topology for the road. In one approach, the number of lanes are associated with one of a segment and a portion about the road. Furthermore, the ESD map may involve adding layers on a standard map and excluding lane geometries about the road. A layer can include various lanes corresponding to the topology for a road segment. However, the ESD map can exclude explicit lane geometries, thereby reducing computational costs and straining communication links when updating maps.

As previously explained, an emission probability can indicate a probability (e.g., a weight) associated with a path potentially taken by the vehicle 100 between states (e.g., vehicle states, trajectories, etc.) upon a distance traveled following a road graph about the road. Computing the emission probabilities can include deriving a perception about the road for various timesteps using the sensor data 250. In one approach, the prediction system 170 projects a road position to various locations within a search radius and assigns a score to the emission probabilities. The search radius can indicate a hypothetical path and trajectory for the vehicle 100 that the prediction system 170 utilizes to derive the topological location 240 using a standard map. For instance, a perception system of the vehicle 100 indicates that a road segment within the search radius has two lanes. The prediction system 170 assigns an elevated emission probability if a standard map confirms that the road has two lanes from current information.

At 420, the estimation module 220 estimates transition probabilities of the road position on a trellis graph from the sensor data 250 and the map. Here, the trellis graph represents the road and potential trajectories by the vehicle 100 in a structure divided among one or more timesteps. A timestep can include various topological states and the emission probabilities and the transition probabilities. Furthermore, as previously explained, estimating the transition probabilities can include using a transition model having a quotient. For instance, the quotient relates one of odometry information and the distance traveled, a lateral offset between the vehicle 100 and a centerline of the road, an area between a trajectory and a path on a road graph associated with the vehicle 100. As previously explained, the road graph can represent a network of roads in a map that simplifies computations through relating road elements. The edges of the road graph represent roads while the nodes represent connections between roads. In this way, the prediction system 170 predicts state probabilities from the emission probabilities and the transition probabilities using a Markov model.

Comparing transition probabilities can include the following. Consider the vehicle 100 having the road position at time t. The vehicle 100 being located at a beginning of the road can indicate that entering another road at t+1 is unlikely. The vehicle 100 can have an increased probability of entering another road at t+1 when located at the end of the road. As such, transition probabilities can depend on external variables that are untracked by a Markov model. In another approach, the external variables can represent a geometric state: xx, yy, and heading. Thus, the prediction system 170 may consider such factors when localizing the vehicle 100 using the sensor data 250 and the map.

At 430, the prediction system 170 predicts state probabilities from the emission and transition probabilities using the Markov model. A state probability can relate and exponentiate a weight derived from an emission probability by distance traveled over various timesteps and road segments drawn from a map. This can include factoring candidate associations with states using the emission and the transition probabilities. In one approach, the Markov model is an HMM that statistically represents vehicle travel with hidden states and observable outputs using probabilities. the vehicle 100 while avoiding HD maps.

In various implementations, the HMM implemented is a stable and efficient protocol that involves making transition computations with distance traveled and independent of a vehicle speed. As previously described, the prediction system 170 relying upon a distance traveled for the vehicle 100 during localization allows a convergence rate to be data independent while maintaining accuracy. This reduces computational cycles associated with sampling data, thereby reducing computational load.

At 440, the prediction system 170 assists with controlling the vehicle 100 from vehicle locations using the state probabilities. Here, the vehicle locations can include the topological location 240. The prediction system 170 assists the vehicle 100 without directly relying upon an HD map, thereby improving localization while reducing system complexity and vehicle costs. As previously explained, the topological location 240 can include one of a road-level localization and a lane-level localization between the vehicle 100, the road, and lanes among the road. Furthermore, localized position about the vehicle 100 may include one of a lane ID, a road ID, a longitudinal position for the road ID using an ESD map, and a heading. As such, the localized position includes comprehensive information about position associated with the vehicle 100.

Moreover, the topological location 240 can include a road ID for the vehicle 100 traveling on the road. The prediction system 170 may identify the topological location 240 along with deriving various road and lane associations. This can include deriving an association between the vehicle 100 and the road using the lane-level localization relative to a standard map. Subsequently, the prediction system 170 globally localizes the vehicle 100 using the association and the standard map. This allows downstream systems such as the vehicle systems 140, automated driving module(s) 160, etc., to control the vehicle 100 with the localization information. Accordingly, the prediction system 170 globally localizes and controls the vehicle 100 using state, emission, and transition probabilities and a map (e.g., a standard map, an ESD map, etc.), thereby avoiding complexities from relying upon an HD map for localization.

FIG. 1 will now be discussed in full detail as an example environment within which the system and methods disclosed herein may operate. In some instances, the vehicle 100 is configured to switch selectively between different modes of operation/control according to the direction of one or more modules/systems of the vehicle 100. In one approach, the modes include: 0, no automation; 1, driver assistance; 2, partial automation; 3, conditional automation; 4, high automation; and 5, full automation. In one or more arrangements, the vehicle 100 can be configured to operate in a subset of possible modes.

In one or more embodiments, the vehicle 100 is an automated or autonomous vehicle. As used herein, “autonomous vehicle” refers to a vehicle that is capable of operating in an autonomous mode (e.g., category 5, full automation). “Automated mode” or “autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU), an application-specific integrated circuit (ASIC), a microprocessor, etc. The vehicle 100 can include one or more data stores 115 for storing one or more types of data. The data store(s) 115 can include volatile and/or non-volatile memory. Examples of suitable data stores 115 include RAM, flash memory, ROM, programmable read-only memory (PROM), erasable programmable read-only memory (EPROM), electrically erasable programmable read-only memory (EEPROM), registers, magnetic disks, optical disks, and hard drives. The data store(s) 115 can be a component of the processor(s) 110, or the data store(s) 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry.

In one or more arrangements, the map data 116 can include one or more terrain maps 117. The terrain map(s) 117 can include information about the terrain, roads, surfaces, and/or other features of one or more geographic areas. The terrain map(s) 117 can include elevation data in the one or more geographic areas. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles can include trees, buildings, curbs, fences, railings, medians, utility poles, statues, monuments, signs, benches, furniture, mailboxes, large rocks, or hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

One or more data stores 115 can include sensor data 119. In this context, “sensor data” means any information about the sensors that the vehicle 100 is equipped with, including the capabilities and other information about such sensors. As will be explained below, the vehicle 100 can include sensor system 120. The sensor data 119 can relate to one or more sensors of the sensor system 120. As an example, in one or more arrangements, the sensor data 119 can include information about one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means a device that can detect, and/or sense something. In at least one embodiment, the one or more sensors detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors may function independently or two or more of the sensors may function in combination. The sensor system 120 and/or the one or more sensors can be operatively connected to the processor(s) 110, the data store(s) 115, and/or another element of the vehicle 100. The sensor system 120 can produce observations about a portion of the environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect information about the vehicle 100 itself. In one or more arrangements, the vehicle sensor(s) 121 can be configured to detect position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, the GNSS, the GPS, a navigation system 147, and/or other suitable sensors. The vehicle sensor(s) 121 can be configured to detect one or more characteristics of the vehicle 100 and/or a manner in which the vehicle 100 is operating. In one or more arrangements, the vehicle sensor(s) 121 can include a speedometer to determine a current speed of the vehicle 100.

Alternatively, or in addition, the sensor system 120 can include one or more environment sensors 122 configured to acquire data about an environment surrounding the vehicle 100 in which the vehicle 100 is operating. “Surrounding environment data” includes data about the external environment in which the vehicle is located or one or more portions thereof. For example, the one or more environment sensors 122 can be configured to sense obstacles in at least a portion of the external environment of the vehicle 100 and/or data about such obstacles. Such obstacles may be stationary objects and/or dynamic objects. The one or more environment sensors 122 can be configured to detect other things in the external environment of the vehicle 100, such as, for example, lane markers, signs, traffic lights, traffic signs, lane lines, crosswalks, curbs proximate to the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more of: radar sensors 123, LIDAR sensors 124, sonar sensors 125, weather sensors, haptic sensors, locational sensors, and/or one or more cameras 126. In one or more arrangements, the one or more cameras 126 can be high dynamic range (HDR) cameras, stereo, or infrared (IR) cameras.

The vehicle 100 can include an input system 130. An “input system” includes components or arrangement or groups thereof that enable various entities to enter data into a machine. The input system 130 can receive an input from a vehicle occupant. The vehicle 100 can include an output system 135. An “output system” includes one or more components that facilitate presenting data to a vehicle occupant.

The vehicle 100 can include the one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, any of the systems or portions thereof may be otherwise combined or segregated via hardware and/or software within the vehicle 100. The vehicle 100 can include a propulsion system 141, a braking system 142, a steering system 143, a throttle system 144, a transmission system 145, a signaling system 146, and/or a navigation system 147. Any of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the prediction system 170, and/or the automated driving module(s) 160 can be operatively connected to communicate with the various vehicle systems 140 and/or individual components thereof. For example, the processor(s) 110 and/or the automated driving module(s) 160 can be in communication to send and/or receive information from the various vehicle systems 140 to control the movement of the vehicle 100. The processor(s) 110, the prediction system 170, and/or the automated driving module(s) 160 may control some or all of the vehicle systems 140 and, thus, may be partially or fully autonomous as defined by the society of automotive engineers (SAE) levels 0 to 5.

The processor(s) 110, the prediction system 170, and/or the automated driving module(s) 160 can be operatively connected to communicate with the various vehicle systems 140 and/or individual components thereof. For example, the processor(s) 110, the prediction system 170, and/or the automated driving module(s) 160 can be in communication to send and/or receive information from the various vehicle systems 140 to control the movement of the vehicle 100. The processor(s) 110, the prediction system 170, and/or the automated driving module(s) 160 may control some or all of the vehicle systems 140.

The processor(s) 110, the prediction system 170, and/or the automated driving module(s) 160 may be operable to control the navigation and maneuvering of the vehicle 100 by controlling one or more of the vehicle systems 140 and/or components thereof. For instance, when operating in an autonomous mode, the processor(s) 110, the prediction system 170, and/or the automated driving module(s) 160 can control the direction and/or speed of the vehicle 100. The processor(s) 110, the prediction system 170, and/or the automated driving module(s) 160 can cause the vehicle 100 to accelerate, decelerate, and/or change direction. As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be an element or a combination of elements operable to alter one or more of the vehicle systems 140 or components thereof responsive to receiving signals or other inputs from the processor(s) 110 and/or the automated driving module(s) 160. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processors 110. Alternatively, or in addition, one or more data stores 115 may contain such instructions.

In one or more arrangements, one or more of the modules described herein can include artificial intelligence elements, e.g., neural network, fuzzy logic, or other machine learning algorithms. Furthermore, in one or more arrangements, one or more of the modules can be distributed among a plurality of the modules described herein. In one or more arrangements, two or more of the modules described herein can be combined into a single module.

The vehicle 100 can include one or more automated driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine position and velocity of the vehicle 100. The automated driving module(s) 160 can determine the location of obstacles, obstacles, or other environmental features including traffic signs, trees, shrubs, neighboring vehicles, pedestrians, etc.

The automated driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module(s) 160 either independently or in combination with the prediction system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data 250. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured to implement determined driving maneuvers. The automated driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk™, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A prediction system comprising:
a memory storing instructions that, when executed by a processor, cause the processor to:
compute emission probabilities for a road position from sensor data and a map about a road;
estimate transition probabilities of the road position on a trellis graph from the sensor data and the map;
predict state probabilities from the emission probabilities and the transition probabilities using a Markov model; and
control a vehicle from vehicle locations using the state probabilities, and the vehicle locations being topological locations.

2. The prediction system of claim 1 further including instructions to:
scale the Markov model using an exponentiation computation according to a distance traveled by the vehicle and the emission probabilities associated with the road, and the state probabilities are associated with the exponentiation computation.

3. The prediction system of claim 2, wherein the instructions to estimate the transition probabilities further include instructions to:
compute the transition probabilities using a transition model according to one of a quotient between odometry information and the distance traveled measured along a road graph, a lateral offset between the vehicle and a centerline of the road, an area between a trajectory and a path on the road graph associated with the vehicle.

4. The prediction system of claim 1, wherein the instructions to compute the emission probabilities further include instructions to:
generate a geometric pose using an extended Kalman filter (EKF) from odometry information and the road position about the vehicle traveling on the road, the geometric pose includes an x-coordinate, a y-coordinate, and a heading for the vehicle; and
the geometric pose is associated with a search radius for the transition probabilities.

5. The prediction system of claim 4, wherein the instructions to compute the emission probabilities further include instructions to:
derive a perception about the road and a timestep using the sensor data;
project the road position to various locations within the search radius; and
assign a score to the emission probabilities from the perception.

6. The prediction system of claim 1, wherein the instructions to predict the state probabilities further include instructions to:
compare topological states for the transition probabilities associated with the vehicle for a path using the trellis graph representing the road, wherein the trellis graph is divided into timesteps between the topological states and the emission probabilities and the transition probabilities form the trellis graph; and
assign a trajectory probability using a difference between a traveled distance by the vehicle and the path between the topological states, and the path is measured along a road graph for the road.

7. The prediction system of claim 1, wherein:
the topological locations include one of a road-level localization and a lane-level localization between the vehicle, the road, and lanes among the road; and
the topological locations include a road identification for the vehicle.

8. The prediction system of claim 7 further including instructions to:
deriving an association between the vehicle and the road using the lane-level localization relative to the map.

9. The prediction system of claim 1, wherein:
the map is an enhanced standard definition (ESD) map that includes centerline information about the road, a number of lanes for the road, and a topology for the road;
the number of lanes are associated with one of a segment and a portion about the road; and
the ESD map excludes lane geometries about the road.

10. A non-transitory computer-readable medium comprising:
instructions that when executed by a processor cause the processor to:
compute emission probabilities for a road position from sensor data and a map about a road;
estimate transition probabilities of the road position on a trellis graph from the sensor data and the map;
predict state probabilities from the emission probabilities and the transition probabilities using a Markov model; and
control a vehicle from vehicle locations using the state probabilities, and the vehicle locations being topological locations.

11. The non-transitory computer-readable medium of claim 10 further including instructions to:
scale the Markov model using an exponentiation computation according to a distance traveled by the vehicle and the emission probabilities associated with the road, and the state probabilities are associated with the exponentiation computation.

12. A method comprising:
computing emission probabilities for a road position from sensor data and a map about a road;
estimating transition probabilities of the road position on a trellis graph from the sensor data and the map;
predicting state probabilities from the emission probabilities and the transition probabilities using a Markov model; and
controlling a vehicle from vehicle locations using the state probabilities, and the vehicle locations being topological locations.

13. The method of claim 12 further comprising:
scaling the Markov model using an exponentiation computation according to a distance traveled by the vehicle and the emission probabilities associated with the road, and the state probabilities are associated with the exponentiation computation.

14. The method of claim 13, wherein estimating the transition probabilities further includes:
computing the transition probabilities using a transition model according to one of a quotient between odometry information and the distance traveled measured along a road graph, a lateral offset between the vehicle and a centerline of the road, an area between a trajectory and a path on the road graph associated with the vehicle.

15. The method of claim 12, wherein computing the emission probabilities further includes:
generating a geometric pose using an extended Kalman filter (EKF) from odometry information and the road position about the vehicle traveling on the road, the geometric pose includes an x-coordinate, a y-coordinate, and a heading for the vehicle; and
the geometric pose is associated with a search radius for the transition probabilities.

16. The method of claim 15, wherein computing the emission probabilities further includes:
deriving a perception about the road and a timestep using the sensor data;
projecting the road position to various locations within the search radius; and
assigning a score to the emission probabilities from the perception.

17. The method of claim 12, wherein predicting the state probabilities further includes:
comparing topological states for the transition probabilities associated with the vehicle for a path using the trellis graph representing the road, wherein the trellis graph is divided into timesteps between the topological states and the emission probabilities and the transition probabilities form the trellis graph; and
assigning a trajectory probability using a difference between a traveled distance by the vehicle and the path between the topological states, and the path is measured along a road graph for the road.

18. The method of claim 12, wherein:
the topological locations include one of a road-level localization and a lane-level localization between the vehicle, the road, and lanes among the road; and
the topological locations include a road identification for the vehicle.

19. The method of claim 18 further comprising:
deriving an association between the vehicle and the road using the lane-level localization relative to the map.

20. The method of claim 12, wherein:
the map is an enhanced standard definition (ESD) map that includes centerline information about the road, a number of lanes for the road, and a topology for the road;
the number of lanes are associated with one of a segment and a portion about the road; and
the ESD map excludes lane geometries about the road.
